(19) United States
(12) Patent Application Publication
(10) Pub. No.: US 2015/0230446 A1
(43) Pub. Date: Aug. 20, 2015

(54) Device for securing line on spool or reel for storage

(71) Applicant: Jeremy Omer Pollender, Marblehead, MA (US)

(72) Inventor: Jeremy Omer Pollender, Marblehead, MA (US)

(21) Appl. No.: 14/606,354

(22) Filed: Jan. 27, 2015

Related U.S. Application Data
(60) Provisional application No. 61/937,504, filed on Feb. 8, 2014.

(51) Int. Cl. A01K 97/00; B65H 75/28

(52) U.S. Cl. CPC A01K 97/00; B65H 75/285

(57) ABSTRACT

A device made for the securing of line on a spool or reel during storage.

### BACKGROUND

When storing line on a spool or reel it unravels possibly becoming tangled with other objects it is stored with. When storing ice fishing tip-ups after fishing, for instance, if the line is not secured it will become entangled with other tip-ups. It is common to store a hook fastened to the line embedded lightly into spool of line on the reel. The hook and barb can become impaled into the line making it a hassle to prepare to un-spool line for fishing.

### BRIEF SUMMARY OF THE INVENTION

The following is intended to be a brief summary of the invention and not a limit the scope of the invention.

The device allows for the securing of line on a reel or spool for storage. The device keeps the line from unraveling when not in use. When connecting the end of the line on the spool to the device it wraps the spool and secures to itself keeping itself and the line secured to the spool.

### BRIEF DESCRIPTION OF THE DRAWINGS

FIG. 1 shows the device in open position, not stored on a spool or reel.

FIG. 2 shows the device just prior to final installation attached to line with a hook through the hole.

FIG. 3 shows the device installed and secured around the spool or reel.

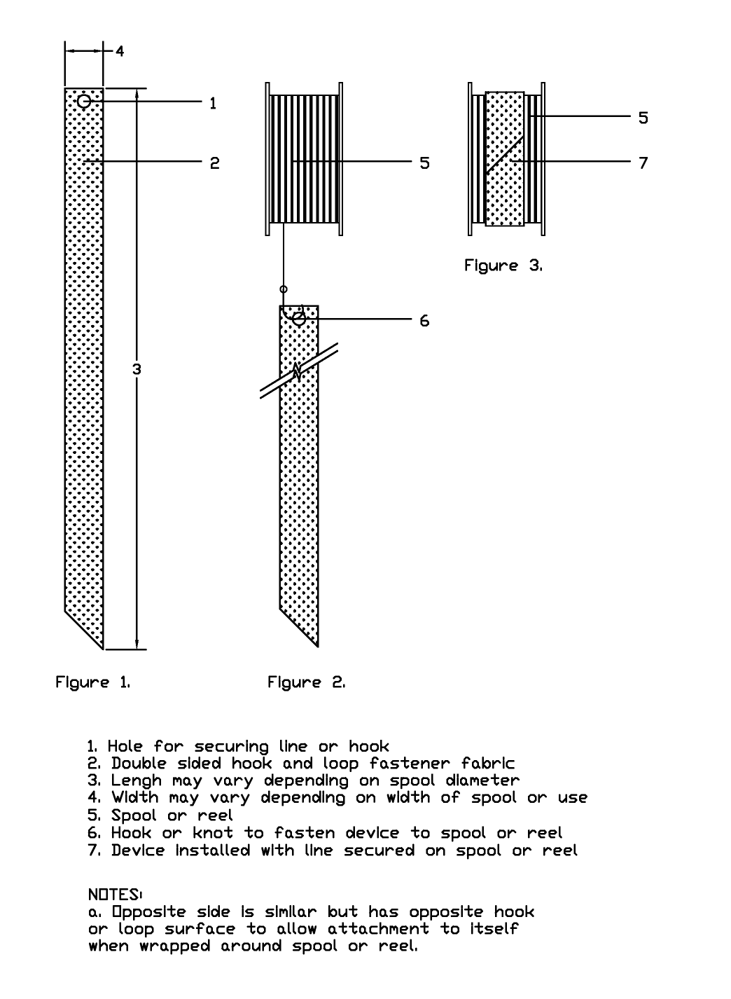

### DETAILED DESCRIPTION

The invention is made primarily of double sided hook and loop fastener fabric material. It has a hole in one end to secure a tag end of a line on a spool or reel. The tag end of the line on the spool or reel may contain a hook similar to when one is using a tip-up for ice fishing. The hook in this instance would be placed through the hole in the end of the device. The line may not contain a hook and may be fastened to the device by means of a knot. In either case the line is wound around a spool or reel, the end of the line is placed in the device via hook or knot and the device and line are wound around the spool or reel. The device via hook and loop fastening is attached to itself securing itself and the line to the spool or reel.

The hole in the end of the device can be made via means of a punch or by melting. A grommet may or may not be placed in the hole.

The length of the device can be made to vary depending on the diameter or circumference of the spool or reel in which it is to be applied. The width of the device can also be made to vary depending on the width of the spool or reel. The double sided hook and loop fastener fabric material is commercially available in varying widths and lengths and is cut to desired length by means of a shear or scissors.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above description embodiment, method and examples, but by all embodiments and methods within the scope and spirit of the invention.

1. A device comprising of double sided hook and loop fastener tape (Velcro) with a hole fashioned at least one end to facilitate the attachment of a line, string or rope. The line, string or rope may be attached to a hook, snap or other hardware prior to attachment to the hole in the device. Once attached to the line, string or rope the device is then wrapped around a spool or reel containing the line, string or rope and attached to itself via the nature of the hook and loop fastener tape. The length and width of the hook and loop fastener tape can vary and be made to accommodate different length and diameter spools or reels. The diameter of the hole may vary and be made to accommodate different size hardware or lines, strings or ropes. One end opposite the one with the hole may be cut on an angle making it easier to un-wrap.

2. When said device is used specifically for securing line on an ice fishing tip-up spool a hook attached to the fishing line is inserted through the hole in one end of the device. The line is wrapped around the spool by hand, the device is then twisted so the hook faces away from the line on the spool and then the device is wrapped around the spool and attaching back over itself.
